(19) United States
(12) Patent Application Publication
(10) Pub. No.: US 2008/0316557 A1
(43) Pub. Date: Dec. 25, 2008

(54) HOLOGRAPHIC RECORDING/REPRODUCING APPARATUS

(75) Inventors: Taek-seong Jeong, Suwon-si (KR); Moon-il Jung, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/961,052

(22) Filed: Dec. 20, 2007

(30) Foreign Application Priority Data
Jun. 21, 2007 (KR) 2007-61123

(51) Int. Cl. G03H 1/12

(52) U.S. Cl. 359/11

(57) ABSTRACT

A holographic recording/reproducing apparatus that easily controls an incident angle of a reference beam and that is less sensitive to a tilt of a holographic recording medium, the holographic recording/reproducing apparatus including: a light source to emit a light; and an optical system to divide the emitted light into a reference beam and a signal beam, and to provide the reference beam and the signal beam to the holographic recording medium, wherein the optical system provides the signal beam to be incident on an upper surface of the holographic recording medium, and provides the reference beam to be guided along the inside of the holographic recording medium by reflection due to a refraction index difference between the holographic recording medium and the outside of the holographic recording medium.

### CROSS-REFERENCE TO RELATED APPLICATION

This application claims the benefit of Korean Application No 2007-61123, filed on Jun. 21, 2007 in the Korean Intellectual Property Office, the disclosure of which is incorporated herein by reference.

### BACKGROUND OF THE INVENTION

1. Field of the Invention

Aspects of the present invention relate to a holographic recording/reproducing apparatus, and more particularly, to a holographic recording/reproducing apparatus that easily controls an incident angle of a reference beam and is less sensitive with respect to a tilt of a holographic recording medium.

2. Description of the Related Art

In hologram technology, an optical signal is reproduced in a stereoscopic image by recording an interference pattern between a signal beam, which carries a signal, and a reference beam at a different angle with respect to the signal beam. Accordingly, optical storage technology for recording and reproducing digital data using holographic technology has recently drawn much attention. In holographic information recording and reproducing technology, recording and reproducing is performed in units of pages by which a plurality of digital data are simultaneously recorded/reproduced in the shape of a two-dimensional image. Thus, an ultra-high speed recording/reproducing system can be implemented. In addition, in the holographic optical storage technology, information that is spatially overlapped and stored can be separated and read using a proper multiplexing technique. Thus, data of several pages can be recorded in an overlapped manner and reproduced in the same region.

FIG. 1A schematically illustrates a principle of recording data using a conventional holographic information recording/reproducing apparatus. Referring to FIG. 1A, a beam splitter 2 splits a laser beam 1 into a reference beam 6 and a signal beam 5. The signal beam 5 passes through a spatial light modulator (SLM) 4, which modulates the signal beam 5 to have a two-dimensional signal pattern, before the signal beam 5 reaches a holographic recording medium M via a lens. An aperture A may be provided on the optical path of the signal beam 5 so that only a desired signal beam can reach the holographic recording medium M. Meanwhile, the reference beam 6 is reflected by a mirror 3, is incident on the holographic recording medium M via another lens at a predetermined angle, and interferes with the signal beam 5. An interference pattern formed in this way is recorded on the holographic recording medium M.

FIG. 1B illustrates a principle of reproducing recorded data using the conventional holographic information recording/reproducing apparatus. Referring to FIG. 1B, when data is reproduced, a reference beam is irradiated on the holographic recording medium M using a laser 8 emitting a beam of the same wavelength as the reference beam 6 used during the recording of the data (illustrated in FIG. 1A). The reference beam should be incident on the holographic recording medium M at the same incident angle as the reference beam 6 when the data was recorded. Then, a signal beam having a two-dimensional signal pattern containing original data is generated when the reference beam is diffracted from the holographic recording medium M. The signal beam is condensed by a lens 9 and detected by a two-dimensional photodetector 10 (such as a charge coupled device (CCD)). In this case, an aperture A is provided on the optical path of the signal beam so that only a desired signal is detected by the photodetector 10 and other signal beams are blocked.

Various multiplexing methods are used for high-density holographic recoding. For example, an angular multiplexing method is frequently used. FIG. 2 is a view explaining the angular multiplexing method. Referring to FIG. 2, a first reference beam 6a together with a first signal beam 5 having predetermined information are incident on a holographic recording medium M at a first incident angle θ₁. The predetermined data is stored in the form of a hologram. Then, a second reference beam 6b together with a second signal beam 5′ having other data are incident on the same location of the holographic recording medium M at a second incident angle θ₂, and the other data is stored. During data reproduction, when the reference beam is incident at the first incident angle θ₁, data of the first signal beam 5 is reproduced. When the reference beam is incident at the second incident beam θ₂, data of the second signal beam 5′ is reproduced.

Generally, an incident angle difference θ₂-θ₁ between the reference beams 6a, 6b is in proportion to a reciprocal value of sin(θ_{S}+θ_{R}) so as to definitely resolve the data of the first signal beam 5 and the second signal beam 5′. In the above, θ_{S} is an incident angle of the signal beam measured with respect to a normal on the holographic recording medium M, and θ_{R} is an incident angle of the reference beam measured with respect to the normal of the holographic recording medium M. Accordingly, as sin(θ_{S}+θ_{R}) is greater (i.e., θ_{S}+θ_{R} is closer to 90 degrees), data of different beams can be accurately resolved although the reference beam is changed at tiny angles. As a result, data having many pages can be recorded on the same location of the holographic recording medium M.

Meanwhile, in the angular multiplexing method, when an incident angle of the reference beam is changed, it is important that only the incident angle be changed and the reference beam be incident at the same location. To achieve this, in a conventional method illustrated in FIGS. 3A and 3B, two galvano mirrors 10a and 10b are simultaneously or alternatively rotated, and a galvano mirror 11 is moved while being rotated along an optical axis. However, in the conventional method illustrated in FIGS. 3A and 38, since the driving units are simultaneously interlocked in order to control two driving units, it is difficult to accurately control the incident angle of the reference beam. In addition, in the conventional method, since the structure for controlling the incident angle of the reference angle is big, it is difficult to apply in a small optical system for a holographic recording/reproducing apparatus.

In addition, the above conventional holographic recording/reproducing apparatus is very sensitive to a tilt of a holographic recording medium M. In particular, the conventional holographic recording/reproducing apparatus is sensitive to a tilt that is generated in a perpendicular direction to a scanning direction of the reference beam. Accordingly, the conventional holographic recording/reproducing apparatus requires an additional element to compensate for the tilt or to maintain the tilt within a desired range. This complicates the structure of the holographic recording/reproducing apparatus.

### SUMMARY OF THE INVENTION

Aspects of the present invention provide a holographic recording/reproducing apparatus that has a simple structure and is less sensitive to a tilt of a holographic recording medium.

Aspects of the present invention also provide a holographic recording/reproducing apparatus that can easily control an incident angle of a reference beam.

According to an aspect of the present invention, there is provided a holographic recording/reproducing apparatus for use with a holographic recording medium, the holographic recording/reproducing apparatus including: a light source to emit a light; and an optical system to divide the emitted light into a reference beam and a signal beam, and to provide the reference beam and the signal beam to the holographic recording medium, wherein optical system provides the signal beam to be incident on an upper surface of the holographic recording medium, and provides the reference beam to be guided inside of the holographic recording medium by reflection due to a refraction index difference between the holographic recording medium and an outside of the holographic recording medium.

According to another aspect of the present invention, the reference beam may be incident on a lateral surface of the holographic recording medium to be guided inside of the holographic recording medium.

According to another aspect of the present invention, the apparatus may further include a mirror facing the lateral surface of the holographic recording medium and reflecting the reference beam to be incident on the lateral surface of the holographic recording medium.

According to another aspect of the present invention, the mirror may be rotatable so as to change an incident angle of the reference beam.

According to another aspect of the present invention, an inclined surface may be formed on a lateral surface of the holographic recording medium, and the reference beam may be incident on an edge of an upper surface of the holographic recording medium and then reflected by the inclined surface to be guided inside of the holographic recording medium.

According to another aspect of the present invention, the apparatus may further include a mirror facing the edge of the upper surface of the holographic recording medium and reflecting the reference beam to be incident on the inclined surface of the holographic recording medium.

According to another aspect of the present invention, the optical system may include: a first beam splitter to reflect a first light of the light emitted from the light source and to transmit a second light of the light emitted from the light source; a second beam splitter to reflect the second light divided by the first beam splitter; a spatial light modulator (SLM) to modulate the second light reflected by the second beam splitter into a signal beam having a two-dimensional signal pattern and to reflect the signal beam towards the second beam splitter; an objective lens to project the signal beam transmitted through the second beam splitter onto the holographic recording medium; and a photodetector to detect a signal beam reproduced from the holographic recording medium.

According to another aspect of the present invention, there is provided a holographic recording medium used in the holographic recording/reproducing apparatus, wherein an inclined surface is formed on a lateral surface of the holographic recording medium.

According to another aspect of the present invention, a reflective coating layer may be formed on a surface of the inclined surface of the holographic recording medium.

According to another aspect of the present invention, there is provided a method of projecting light beams on to a holographic recording medium to record and/or reproduce data on the holographic recording medium, the method including: providing a signal beam to be incident on an upper surface of the holographic recording medium; and providing a reference beam to be guided inside of the holographic recording medium by reflection due to a refraction index difference between the holographic recording medium and an outside of the holographic recording medium.

According to another aspect of the present invention, there is provided a holographic recording/reproducing apparatus to record and/or reproduce data to/from a holographic recording medium, the apparatus including: an optical system to provide a signal beam to be incident on an upper surface of the holographic recording medium, and to provide a reference beam to be guided inside of the holographic recording medium by reflection due to a refraction index difference between the holographic recording medium and an outside of the holographic recording medium so as to transfer data using the signal beam due to an interference of the signal and reference beams at the medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A and 11B are views illustrating a principle of recording data using holographic technology of a conventional holographic information recording/reproducing apparatus;

FIG. 2 is a view explaining the angular multiplexing method;

FIGS. 3A and 3B are views illustrating a structure of controlling an incidence angle of a reference beam in an angular multiplexing method;

FIG. 4 is a schematic view illustrating a structure of a holographic recording/reproducing apparatus according to an embodiment of the present invention;

FIG. 5 is a view illustrating a structure for irradiating a reference beam onto a holographic recording medium through a mirror for controlling the angle of the reference beam; and

FIG. 6 is a view explaining a method of irradiating a reference beam R according to another embodiment of the present invention.

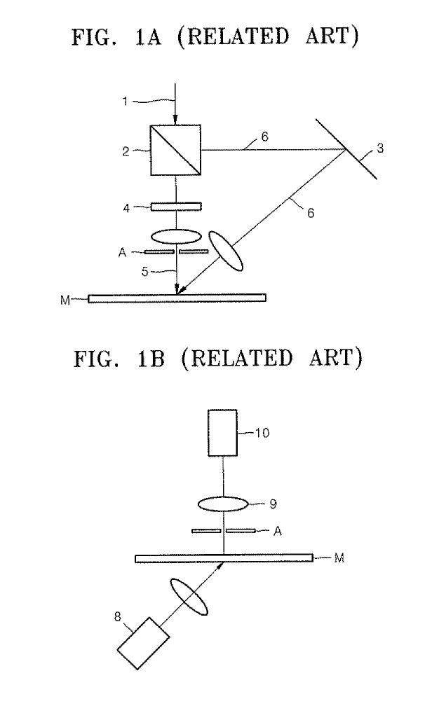

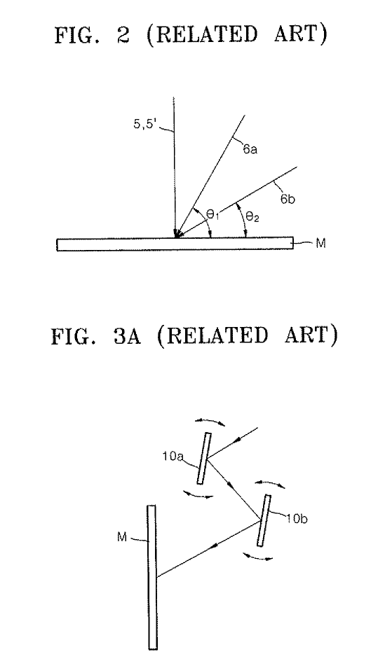

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 4 is a schematic view illustrating a structure of a holographic recording/reproducing apparatus 20 according to an embodiment of the present invention. Referring to FIG. 4, the holographic recording/reproducing apparatus 20 includes a light source 21, a first beam splitter 22, a signal beam providing unit, a photodetector 26, and a mirror 27. The light source 21 emits light, and the first beam splitter 22 divides the emitted light into a reference beam R and another beam. The signal beam providing unit modulates the another beam into the signal beam S having a two-dimensional signal pattern and provides the modulated signal beam S to a holographic recording medium M. The photodetector 26 detects the signal beam S reproduced from the holographic recording medium M, and the mirror 27 provides the reference beam R to the holographic recording medium M. In addition, the shown signal beam providing unit includes a second beam splitter 23, a spatial light modulator (SLM) 24 and an objective lens 25. The second beam splitter 23 reflects the other beam transmitted from the first beam splitter 22 towards the SLM 24. The SLM 24 modulates the other beam from the second beam splitter 23 into the signal beam S having the two-dimensional signal pattern and reflects the signal beam S back towards the second beam splitter 23. The objective lens 25 projects the signal beam S onto the holographic recording medium M. In addition, an aperture A limiting the size of the signal beam S is further provided on an optical path of the signal beam S. However, it is understood that according to other aspects, the aperture A is not included in the holographic recording/reproducing apparatus 20. Moreover, it is understood that, while not shown, the apparatus 20 can include other elements, such as a controller to control recording and/or reproducing, a motor to rotate the medium and/or the mirror 27, and an encoder/decoder to encode/decode data for the purpose of recording to or reproducing from the holographic recording medium M.

Referring to the data recording operation of the holographic recording/reproducing apparatus 20 illustrated in FIG. 4, a part of the light emitted from the light source 21 is transmitted through the first beam splitter 22 to be used as the signal beam S, the other part of the light is reflected by the first beam splitter 22 to be used as the reference beam R. The light transmitted through the first beam splitter 22 is reflected by the second beam splitter 23 to be incident on the SLM 24. The SLM 24 modulates the incident light thereon into the signal beam S having the two-dimensional signal pattern, and then reflects the signal beam S back towards the second beam splitter 23. The modulated signal beam S is transmitted through the second beam splitter 23 and the objective lens 25 to the holographic recording medium M. The second beam splitter 23 may be a polarization beam splitter that reflects the light from the first beam splitter 22 and transmits the light from the SLM 24. It is understood that the structure and the locations of the second beam splitter 23, the SLM 24 and the objective lens 25, which provide the signal beam S, may vary according to design. For example, the SLM 24 may be provided between the second beam splitter 23 and the objective lens 25. In this case, the SLM 24 may be of a transmission-type and not of a reflective-type. Accordingly, the specific structure of the signal beam providing unit may be variously changed according to aspects of the present invention and is not limited to the shown example.

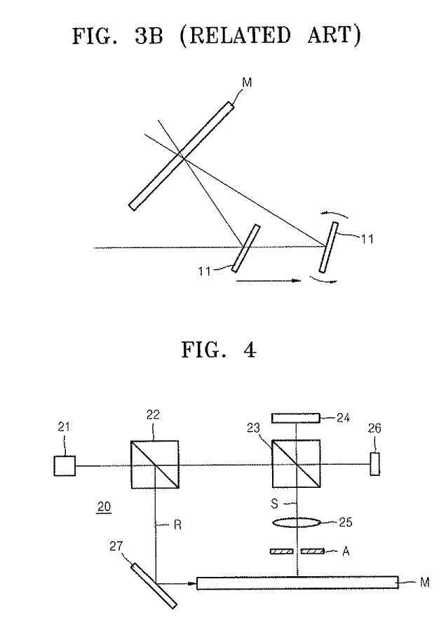

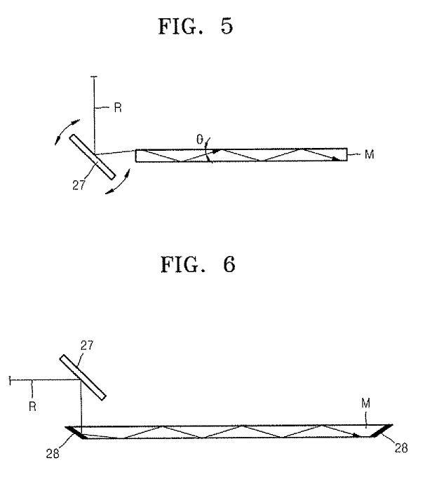

Meanwhile, the light reflected by the first beam splitter 22 is reflected by the mirror 27 to be provided to the holographic recording medium M as the reference beam R. According to aspects of the present invention, the signal beam S is provided so as to be incident on an upper surface of the holographic recording medium M, as in the conventional art. However, as illustrated in FIG. 4, the reference beam R is provided so as to be reflected by the mirror 27 to be incident on a lateral surface of the holographic recording medium M. Then, as illustrated in FIG. 5, the reference beam R is guided completely by reflection inside the holographic recording medium M due to the refraction index difference between the holographic recording medium M and the outside of the holographic recording medium M. Then, the reference beam R interferes with the signal beam S incident on the upper surface of the holographic recording medium M. Accordingly, as illustrated in FIG. 5, the angle of the reference beam R can be easily adjusted for angular multiplexing by only rotating the mirror 27. Thus, in the holographic recording/reproducing apparatus 20 according to aspects of the present invention, there is no need for a complex method of adjusting the angle of the reference beam R, as illustrated in FIGS. 3A and 3B. Since the reference beam R is completely reflected in the holographic recording medium M, the angle 0 of the reference beam R may be adjusted so as to be in the range of 0° to 45° when the refraction index of a transparent substrate of the holographic recording medium M is about 1.5. However, it is understood that other ranges might be used, and that other materials having other refraction indices can be used.

As described above, the reference beam R and the signal beam S may be at an angle of about 90° with respect to each other in order to accurately resolve data recorded at the same location and reproduce the data using the angular multiplexing method. As illustrated in FIG. 4, the reference beam R and the signal beam S proceed in an almost perpendicular direction to each other. Accordingly, according to aspects of the present invention, since the selectivity of the holographic recording/reproducing apparatus 20 is good, many more pages can be recorded at the same location of the holographic recording medium M than in the conventional art.

In addition, when the reference beam R is scanned for angular multiplexing, tolerances with respect to the tilt of the holographic recording medium M are proportional to a reciprocal value of cosθ_{R}, wherein the tilt occurs in a direction perpendicular to the scanning direction of the reference beam R, and θ_{R} is an incident angle measured with respect to a normal line of the holographic recording medium M. Accordingly, since a greater value of the cosθ_{R} leads to smaller tolerances, recording/reproducing is affected by the tilt. In addition, since a smaller value of the cosθ_{R} leads to greater tolerances, recording/reproducing is slightly influenced by the tilt. As illustrated in FIG. 4, since θ_{R} is about 90 degrees, the holographic recording/reproducing apparatus 20 is less sensitive to tilt. As a result, since there is no need for an additional complicated method or device to prevent or compensate for the tilt, the structure of the holographic recording/reproducing apparatus 20 is simple.

When the holographic recording/reproducing apparatus 20 reproduces data, the reference beam R is also incident thorough the lateral surface of the holographic recording medium M. Then, while the reference beam R is completely reflected inside of the holographic recording medium M, data recorded in proceeding paths of the reference beam R are reproduced as the signal beam S having the two-dimensional signal pattern. Since only the desired signal beam S of the reproduced signal beam S passes through the aperture A, the desired signal beam S is provided to the second beam splitter 23. The signal beam S transmitted through the aperture A is reflected by the second beam splitter 23, and then detected by the photodetector 26 (e.g., charge coupled device (CCD)). Thus, a signal pattern stored in the holographic recording medium M can be read.

FIG. 6 is a view illustrating a method in which a reference beam R is supplied according to another embodiment of the present invention. Referring to FIG. 6, a mirror 27 reflecting the reference beam R is provided so as to face an edge of an upper surface of a holographic recording medium M. Furthermore, an inclined surface 28 is formed on the lateral surface of the holographic recording medium M. Accordingly, as illustrated in FIG. 6, the reference beam R reflected by the mirror 27 is incident on the edge of the upper surface of the holographic recording medium M to be reflected by the inclined surface 28, and then is provided to the inside of the holographic recording medium M completely by reflection. Even in this case, the incident angle of the reference beam R can be adjusted by rotating the mirror 27. In addition, a reflective coating layer may be formed on a surface of the inclined surface 28 in order to improve the reflectivity of the reference beam R with respect to the inclined surface 28.

The holographic recording/reproducing apparatus 20 according to aspects of the present invention is less sensitive to the tilt of the holographic recording medium M. Accordingly, there is no need for an additional element in the holographic recording/reproducing apparatus 20 according to aspects the present invention in order to compensate for or maintain the tilt within a predetermined range. As a result, the entire structure of the holographic recording/reproducing apparatus 20 is very simple.

In addition, the holographic recording/reproducing apparatus according to aspects of the present invention can easily control an incident angle of the reference beam R, and thus an optical system can be simply realized.

Although a few embodiments of the present invention have been shown and described it would be appreciated by those skilled in the art that changes may be made in this embodiment without departing from the principles and spirit of the invention, the scope of which is defined in the claims and their equivalents.

What is claimed is:

1. A holographic recording/reproducing apparatus to record and/or reproduce data to/from a holographic recording medium, the apparatus comprising:
a light source to emit a light; and
an optical system to divide the emitted light into a reference beam and a signal beam, and to provide the reference beam and the signal beam to the holographic recording medium to form an interference pattern to transfer the data with respect to the holographic storage medium,
wherein the optical system provides the signal beam to be incident on an upper surface of the holographic recording medium, and provides the reference beam to be guided inside of the holographic recording medium by reflection due to a refraction index difference between the holographic recording medium and an outside of the holographic recording medium.

2. The apparatus as claimed in claim 1, wherein the optical system provides the reference beam to be incident on a lateral surface of the holographic recording medium in order to be guided inside of the holographic recording medium.

3. The apparatus as claimed in claim 2, further comprising:
a mirror facing the lateral surface of the holographic recording medium and reflecting the reference beam from the optical system to be incident on the lateral surface of the holographic recording medium.

4. The apparatus as claimed in claim 3, wherein the mirror is rotatable so as to change an incident angle of the reference beam.

5. The apparatus as claimed in claim 1, wherein:
the holographic recording medium includes a lateral surface having an inclined surface formed thereon; and
the optical system provides the reference beam to be incident on an edge of an upper surface of the holographic recording medium such that the reference beam is reflected by the inclined surface to be guided inside of the holographic recording medium.

6. The apparatus as claimed in claim 5, further comprising:
a mirror facing the edge of the upper surface of the holographic recording medium and reflecting the reference beam from the optical system to be incident on the inclined surface of the holographic recording medium.

7. The apparatus as claimed in claim 6, wherein the mirror is rotatable so as to change an incident angle of the reference beam.

8. The apparatus as claimed in claim 1, wherein the optical system comprises:
a first beam splitter to reflect a first light of the light emitted from the light source and to transmit a second light of the light emitted from the light source;
a spatial light modulator (SLM) to modulate the second light into a signal beam having a two-dimensional signal pattern; and
an objective lens to project the signal beam onto the holographic recording medium

9. The apparatus as claimed in claim 8, wherein the optical system further comprises:
a second beam splitter to reflect the second light divided by the first beam splitter to the SLM.

10. The apparatus as claimed in claim 9, wherein:
the SLM reflects the signal beam to the second beam splitter; and
the second beam splitter transmits the signal beam to the objective lens.

11. The apparatus as claimed in claim 1, wherein the optical system further comprises:
a photodetector to detect a signal beam reproduced from the holographic medium.

12. A holographic recording medium used in a holographic recording/reproducing apparatus that provides a signal beam to be incident on a surface of the holographic recording medium and a reference beam to be guided inside of the holographic recording medium, the medium comprising:
a surface on which the signal beam is incident; and
an inclined surface formed on a lateral surface of the holographic recording medium so as to guide the reference beam to be reflected within the medium due to a refractive index difference between the medium and an outside of the medium.

13. The holographic recording medium as claimed in claim 12, wherein a reflective coating layer is formed on a surface of the inclined surface to reflect the reference beam into the medium.

14. A method of projecting light beams on to a holographic recording medium to record and/or reproduce data on the holographic recording medium, the method comprising:
providing a signal beam to be incident on an upper surface of the holographic recording medium; and
providing a reference beam to be guided inside of the holographic recording medium by reflection due to a refraction index difference between the holographic recording medium and an outside of the holographic recording medium so as to interfere with the signal beam to transfer the data with respect to the medium using the signal beam.

15. The method as claimed in claim 14, wherein the providing of the reference beam comprises:
providing the reference beam to be incident on a lateral surface of the holographic recording medium in order to be guided inside of the holographic recording medium.

16. The method as claimed in claim 15, wherein the providing of the reference beam to be incident on the lateral surface comprises:
reflecting, with a mirror, the reference beam to be incident on the lateral surface of the holographic recording medium, the lateral surface being substantially perpendicular to the upper surface.

17. The method as claimed in claim 16, further comprising rotating the mirror so as to change an incident angle of the reference beam on the lateral surface.

18. The method as claimed in claim 14, wherein:
the holographic recording medium includes a lateral surface having an inclined surface; and
the providing of the reference beam comprises providing the reference beam to be incident on the inclined surface through the upper surface of the holographic recording medium such that the reference beam is reflected by the inclined surface to be guided inside of the holographic recording medium.

19. The method as claimed in claim 18, wherein the providing of the reference beam to be incident on the edge of the upper surface comprises:
reflecting the reference beam, with a mirror facing the edge of the upper surface of the holographic recording medium, to be incident on the inclined surface of the holographic recording medium.

20. The method as claimed in claim 19, further comprising rotating the mirror so as to change an incident angle of the reference beam on the inclined surface.

21. The method as claimed in claim 14, further comprising dividing the light by reflecting a first part of the light to form the reference beam, transmitting a second part of the light, and modulating the transmitted second part into the signal beam having a two-dimensional signal pattern.

22. A holographic recording/reproducing apparatus to record and/or reproduce data to/from a holographic recording medium, the apparatus comprising:
an optical system to provide a signal beam to be incident on an upper surface of the holographic recording medium, and to provide a reference beam to be guided inside of the holographic recording medium by reflection due to a refraction index difference between the holographic recording medium and an outside of the holographic recording medium so as to transfer data using the signal beam due to an interference of the signal and reference beams at the medium.

23. The apparatus as claimed in claim 22, wherein the optical system provides the reference beam to be incident on a lateral surface of the holographic recording medium in order to be guided inside of the holographic recording medium.

24. The apparatus as claimed in claim 22, wherein:
the holographic recording medium includes a lateral surface having an inclined surface formed thereon; and
the optical system provides the reference beam to be incident on an edge of an upper surface of the holographic recording medium such that the reference beam is reflected by the inclined surface to be guided inside of the holographic recording medium.

25. The apparatus as claimed in claim 22, further comprising:
a mirror that is rotatable to change an incident angle of the reference beam on the lateral side so as to reflect the reference beam from the optical system inside of the holographic recording medium.
